(19) United States
(12) Patent Application Publication
(10) Pub. No.: US 2026/0084394 A1
(43) Pub. Date: Mar. 26, 2026

(54) INTELLIGENT DESKTOP HEAT PRESS MACHINE AND CONTROL METHOD

(71) Applicant: Shenzhen Xiyang Technology Co., Ltd., Shenzhen (CN)

(72) Inventor: Huayao Tang, Guangshui (CN)

(21) Appl. No.: 18/965,929

(22) Filed: Dec. 2, 2024

(30) Foreign Application Priority Data
Sep. 23, 2024 (CN) 2024113227411

(51) Int. Cl. B30B 15/06

(52) U.S. Cl. CPC B30B 15/064

(57) ABSTRACT

Provided are an intelligent desktop heat press machine and a control method. The intelligent desktop heat press machine includes: a base; a lifting platen disposed on the base, where the lifting platen is movable relative to the base, and configured to bear a to-be-processed workpiece; a lifting drive component disposed on the base, where the lifting drive component is connected to the lifting platen, and configured to drive the lifting platen to ascend and descend; an upper platen provided with a heating plate, where one end of the upper platen is rotatably connected to the base to switch between a closed state and an open state, in the closed state, the other end of the upper platen is fixedly connected to the base, and in the open state, the other end of the upper platen is spaced from the base; and a control part.

### TECHNICAL FIELD

This application relates to the technical field of small heat press machines, and in particular, relates to an intelligent desktop heat press machine and a control method.

### BACKGROUND

Heat press machines are widely applied. However, a small heat press product, especially a desktop heat press machine still needs to be manually pressed by a user due to limited intelligentization. High-time operation imposes a high requirement for labor intensity of the user, and pressing force cannot be controlled, and consequently, working efficiency is low.

### SUMMARY

This application is intended to resolve at least one of the technical problems existing in the related technology. In view of this, this application discloses an intelligent desktop heat press machine and a control method.

According to a first aspect, the present disclosure provides an intelligent desktop heat press machine, including:
a base;
a lifting platen disposed on the base, wherein the lifting platen is movable relative to the base, and the lifting platen is configured to bear a to-be-processed workpiece;
a lifting drive component disposed on the base, wherein the lifting drive component is connected to the lifting platen, and the lifting drive component is configured to drive the lifting platen to ascend and descend;
an upper platen provided with a heating plate, wherein one end of the upper platen is rotatably connected to the base to switch between a closed state and an open state; in the closed state, the other end of the upper platen is fixedly connected to the base, and the heating plate and the lifting platen are disposed opposite to each other; and in the open state, the other end of the upper platen is spaced from the base; and
a control part, wherein the lifting drive component and the heating plate are both electrically connected to the control part, and the control part is configured to: control the heating plate to start working when the upper platen is in the closed state, and control the lifting drive component to drive the lifting platen to move toward the heating plate when a temperature of the heating plate reaches a preset temperature.

In an embodiment of the present disclosure, the intelligent desktop heat press machine further comprises an induction component, the induction component is disposed on the base, the induction component is electrically connected to the control part, and the induction component is configured to detect a position of the lifting platen.

In an embodiment of the present disclosure, the base comprises a mounting cavity, the lifting drive component comprises a lifting motor disposed in the mounting cavity, and a drive end of the lifting motor is connected to the lifting platen.

In an embodiment of the present disclosure, the induction component is at least partially located in the mounting cavity.

In an embodiment of the present disclosure, the induction component comprises an inductor and an induction sheet, the inductor is disposed in the mounting cavity, one end of the induction sheet is connected to the lifting platen, and the inductor is configured to induct a position of the induction sheet.

In an embodiment of the present disclosure, the intelligent desktop heat press machine further comprises a heat dissipation fan, the heat dissipation fan is disposed on the upper platen, and the heat dissipation fan is configured to convey air to the heating plate.

In an embodiment of the present disclosure, one end of the upper platen is rotatably connected to the base through a damping hinge.

In an embodiment of the present disclosure, the intelligent desktop heat press machine further comprises a silicone pad, and the silicone pad is disposed on a side that is of the lifting platen and that is away from the base.

In an embodiment of the present disclosure, the intelligent desktop heat press machine further comprises a locking component, the locking component is disposed on the upper platen; in the closed state, the locking component is fixedly connected to the upper platen and the base; and in the open state, the locking component is spaced from the base.

According to a second aspect, the present disclosure provides a control method, comprising:

controlling a lifting drive component to drive a lifting platen to move upward, such that a to-be-processed workpiece fits a heating plate; and
controlling the lifting drive component to drive the lifting platen to move downward, such that the to-be-processed workpiece is separated from the heating plate.

Additional aspects and advantages of this application will be partly provided in the following description, and partly become evident in the following description or understood through the practice of this application.

### BRIEF DESCRIPTION OF THE DRAWINGS

To describe the technical solutions in the embodiments of the present disclosure or in the related art more clearly, the following briefly describes the accompanying drawings required for describing the embodiments or the related art. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of an intelligent desktop heat press machine according to the present disclosure;

FIG. 2 is a schematic structural diagram of an intelligent desktop heat press machine according to the present disclosure, where an upper platen in an open state;

FIG. 3 is a sectional view of an intelligent desktop heat press machine according to the present disclosure; and

FIG. 4 is a schematic flowchart of a control method according to the present disclosure.

### DETAILED DESCRIPTION OF THE EMBODIMENTS

In order to make the objectives, technical solutions and advantages of this application clearer, the following clearly and completely describes the technical solutions in this application with reference to the accompanying drawings in this application. Apparently, the described embodiments are some rather than all of the embodiments of this application. All other embodiments obtained by those of ordinary skill in the art based on the embodiments of this application without creative efforts should fall within the protection scope of this application.

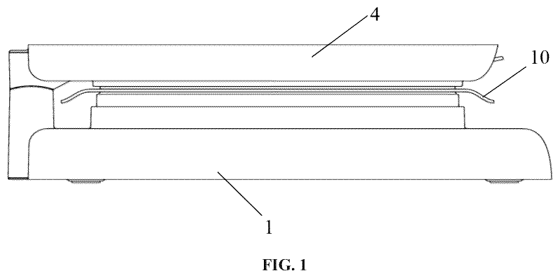

The following describes an intelligent desktop heat press machine and a control method in this application with reference to FIG. 1 to FIG. 4.

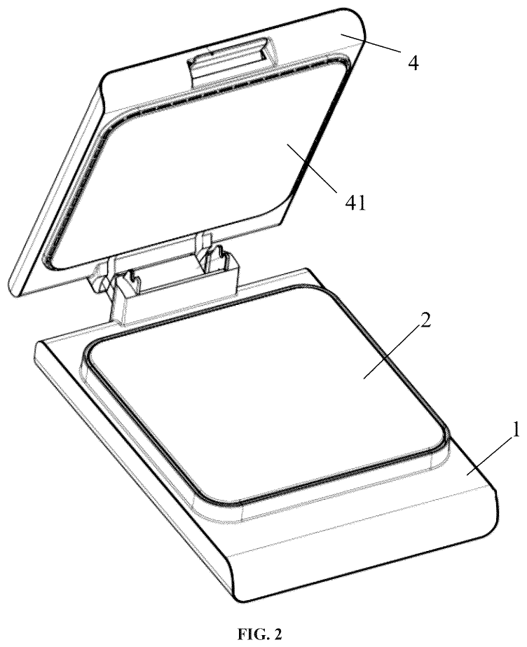

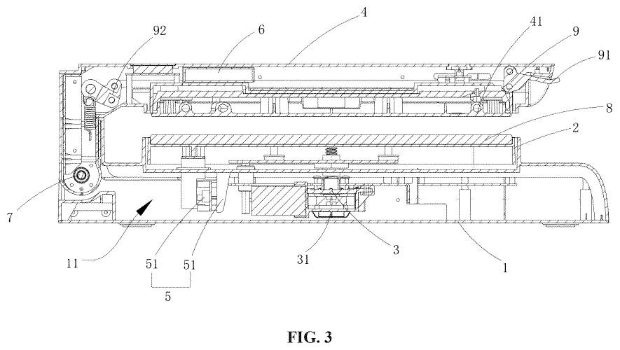

According to an embodiment in a first aspect of this application, as shown in FIG. 1, FIG. 2, and FIG. 3, the intelligent desktop heat press machine includes:
a base 1, a lifting platen 2, a lifting drive component 3, an upper platen 4, and a control part.

The lifting platen 2 is disposed on the base 1, where the lifting platen 2 is movable relative to the base 1, and the lifting platen 2 is configured to bear a to-be-processed workpiece 10.

The lifting drive component 3 is disposed on the base 1, where the lifting drive component 3 is connected to the lifting platen 2, and the lifting drive component 3 is configured to drive the lifting platen 2 to ascend and descend.

The upper platen 4 is provided with a heating plate 41, where one end of the upper platen 4 is rotatably connected to the base 1 to switch between a closed state and an open state, in the closed state, the other end of the upper platen 4 is fixedly connected to the base 1, the heating plate 41 and the lifting platen 2 are disposed opposite to each other, and in the open state, the other end of the upper platen 4 is spaced from the base 1.

The lifting drive component 3 and the heating plate 41 are both electrically connected to the control part, and the control part is configured to: control the heating plate 41 to start working when the upper platen 4 is in the closed state, and control the lifting drive component 3 to drive the lifting platen 2 to move toward the heating plate 41 when a temperature of the heating plate 41 reaches a preset temperature.

According to the intelligent desktop heat press machine in this embodiment of this application, the to-be-processed workpiece is placed on the lifting platen 2, and the upper platen 4 is rotated, so that the upper platen 4 is in the closed state. Then, the heating plate 41 is controlled by the control part to start working, so that the temperature of the heating plate 41 gradually increases. When the temperature of the heating plate 41 reaches the preset temperature, the lifting drive component 3 is controlled by the control part to drive the lifting platen 2 to move upward, that is, move toward the heating plate 41, so that the to-be-processed workpiece 10 tightly fits the heating plate 41, to implement a heat-pressing operation on the to-be-processed workpiece 10. After the heat-pressing operation is completed, the lifting drive component 3 is controlled by the control part to drive the lifting platen 2 to move downward, that is, move in a direction away from the heating plate 41, so that the to-be-processed workpiece 10 is separated from the heating plate 41. The upper platen 4 is rotated, so that the upper platen 4 is in the open state, and the heat-pressed to-be-processed workpiece 10 is taken out. In other words, in this application, the lifting platen 2 is driven by the lifting drive component 3 to move toward the heating plate 41, so that the to-be-processed workpiece 10 is clamped between the lifting platen 2 and the heating plate 41, and the to-be-processed workpiece 10 is automatically clamped. The user does not need to press, so that an automatic heat-pressing operation of the to-be-processed workpiece 10 is implemented. In addition, pressing force is controllable, so that the intelligent level of the intelligent desktop heat press machine is improved, and working efficiency is improved.

It may be understood that, in a heat-pressing process of the to-be-processed workpiece 10, the lifting drive component 3 is controlled by the control part, so that the lifting drive component 3 applies stable force to the to-be-processed workpiece 10. Therefore, extrusion force on the to-be-processed workpiece 10 is kept unchanged in the heat-pressing process, so that a heat-pressing effect is ensured.

It may be understood that, a state of the upper platen 4 can be detected through a detection part, or a state of the upper platen 4 can be determined according to a user input.

In an embodiment of this application, as shown in FIG. 1, FIG. 2, and FIG. 3, the intelligent desktop heat press machine further includes an induction component 5, the induction component 5 is disposed on the base 1, the induction component 5 is electrically connected to the control part, and the induction component 5 is configured to detect a position of the lifting platen 2.

It may be understood that, the induction component 5 may be configured to: detect the position of the lifting platen 2 and transmit a detection signal to the control part, so that the control part can determine the position of the lifting platen 2, namely, a height of the lifting platen 2. It may be determined, according to the position of the lifting platen 2, whether the to-be-processed workpiece 10 is clamped between the lifting platen 2 and the heating plate 41, and a size of clamping force on the to-be-processed workpiece 10 may be further determined. In other words, in this embodiment, the position of the lifting platen 2 is detected through the induction component 5, so that automatic clamping of the to-be-processed workpiece 10 can be implemented, and extrusion force on the to-be-processed workpiece 10 can be kept stable.

In an embodiment of this application, as shown in FIG. 1, FIG. 2, and FIG. 3, the base 1 is formed with a mounting cavity 11, the lifting drive component 3 includes a lifting motor 31 disposed in the mounting cavity 11, and a drive end of the lifting motor 31 is connected to the lifting platen 2.

It may be understood that, the lifting motor 31 can drive the lifting platen 2 to move up and down, to implement automatic adjustment on the position of the lifting platen 2. The lifting motor 31 is disposed in the mounting cavity 11 of the base 1, so that space of the base 1 is effectively utilized, and miniaturization of the heat press is facilitated.

In some examples, a mounting groove is formed in the base 1, the lifting platen 2 is disposed in the mounting groove, and a first through hole that communicates with the mounting cavity 11 is provided on a groove bottom of the mounting groove. A retractable end of the lifting motor 31 penetrates the first through hole and is connected to the lifting platen 2, to drive the lifting platen 2 to move up and down.

In an embodiment of this application, the induction component 5 is at least partially located in the mounting cavity 11.

It may be understood that, the induction component 5 is at least partially disposed in the mounting cavity 11, so that space of the base 1 is effectively utilized, and miniaturization of the heat press is facilitated.

In an embodiment of this application, as shown in FIG. 1, FIG. 2, and FIG. 3, the induction component 5 includes an inductor 51 and an induction sheet 52, the inductor 51 is disposed in the mounting cavity 11, one end of the induction sheet 52 is connected to the lifting platen 2, and the inductor 51 is configured to induct a position of the induction sheet 52.

It may be understood that, the induction sheet 52 is connected to the lifting platen 2. In this case, the position of the induction sheet 52 changes with ascending and descending of the lifting platen 2. The inductor 51 can be configured to induct the position of the induction sheet 52. In this case, a position of the lifting platen 2 can be judged through the position of the induction sheet 52, to implement automatic detection on the position of the lifting platen 2.

In an embodiment of this application, as shown in FIG. 1, FIG. 2, and FIG. 3, the intelligent desktop heat press machine further includes a heat dissipation fan 6, the heat dissipation fan 6 is disposed on the upper platen 4, and the heat dissipation fan 6 is configured to convey air to the heating plate 41.

It may be understood that, the heat dissipation fan 6 is electrically connected to the control part. When the heat press is in a working process, the control part is configured to control the heat dissipation fan 6 to be in a working state, so that air is conveyed to the heating plate 41 by the heat dissipation fan 6. This helps out-emission of heat, reduces an overall temperature of the upper platen 4, and avoids a too high overall temperature of the upper platen 4.

In an embodiment of this application, as shown in FIG. 1, FIG. 2, and FIG. 3, one end of the upper platen 4 is rotatably connected to the base 1 through a damping hinge 7.

It may be understood that, one end of the upper platen 4 is connected to the base 1 through the damping hinge 7, so that the upper platen 4 is rotatable relative to the base 1.

A maximum included angle between the upper platen 4 and the base 1 is 90 degrees. The upper platen 4 can be suspended at an angle within a range of 0 degree to 90 degrees through the damping hinge 7.

In an embodiment of this application, as shown in FIG. 1, FIG. 2, and FIG. 3, the intelligent desktop heat press machine further includes a silicone pad 8, and the silicone pad 8 is disposed at a side that is of the lifting platen 2 and that is away from the base 1.

It may be understood that, the to-be-processed workpiece 10 is placed on the silicone pad 8, and the silicone pad 8 can be configured to buffer, so that the to-be-processed workpiece 10 can be effectively prevented from being damaged. In addition, friction force of the silicone pad 8 is large, and placing stability of the to-be-processed workpiece 10 can be greatly improved.

In an embodiment of this application, as shown in FIG. 1, FIG. 2, and FIG. 3, the intelligent desktop heat press machine further includes a locking component 9, the locking component 9 is disposed on the upper platen 4, in the closed state, the locking component 9 is fixedly connected to the upper platen 4 and the base 1, and in the open state, the locking component 9 is spaced from the base 1.

It may be understood that, when the locking component 9 is in a locked state, the upper platen 4 and the base 1 can be locked and connected together. When the locking component 9 is an unlocked state, the upper platen 4 can rotate relative to the base 1.

A clamping groove is formed on the base 1. The locking component 9 includes an unlocking platen 91 and a connecting rod 92. One end of the unlocking platen 91 is protruded from the upper platen 4, and the other end of the unlocking platen 91 is connected to one end of the connecting rod 92.

The unlocking platen 91 is rotatably disposed on the upper platen 4, to drive the other end of the connecting rod 92 to get close to or away from the clamping groove, and a clamping block is formed at the other end of the connecting rod 92. In the closed state, the clamping block is disposed in the clamping groove. In the open state, the clamping block is spaced from the clamping groove.

It may be understood that, the upper platen 4 is rotated, so that the other end of the upper platen 4 moves toward the base 1. When an included angle between the upper platen 4 and the base 1 is 0 degrees, the unlocking platen 91 is rotated in a first direction, and the unlocking platen 91 drives the other end of the connecting rod 92 to move, so that the clamping block at the other end of the connecting rod 92 is inserted into the clamping groove. In this case, the connecting rod 92 and the base 1 are connected together, so that the upper platen 4 is connected to the base 1.

The unlocking platen 91 is rotated in a second direction (the second direction is opposite to the first direction), and the unlocking platen 91 drives the other end of the connecting rod 92 to move, so that the clamping block at the other end of the connecting rod 92 is separated from the clamping groove. In this case, the connecting rod 92 is not connected to the base 1 and the upper platen 4, so that the upper platen 4 can freely rotate.

In some examples, the locking component 9 further includes a tension spring 93, and the tension spring 93 is connected to the connecting rod 92 and the base 1, to provide tension force to the unlocking platen 91.

In an embodiment of this application, an accommodating cavity is formed on the upper platen 4. The heat dissipation fan 6 and the connecting rod 92 are disposed in the accommodating cavity. A length direction of the connecting rod 92 is consistent with a length direction of the accommodating cavity, to effectively utilize space of the upper platen 4, so that the structure of the upper platen 4 is compact, and miniaturization of the heat press is facilitated.

The induction sheet 52, the inductor 51, and the lifting motor 31 are sequentially designed in the length direction of the mounting cavity 11, so that space of the mounting cavity 11 is effectively utilized, and miniaturization of the heat press is facilitated.

In an embodiment of this application, an ejector rod and a drive part connected to the ejector rod are disposed in the mounting cavity 11. One end of the ejector rod is connected to the drive part. A through hole is provided on the lifting platen 2, and the other end of the ejector rod penetrates the through hole. The drive part is configured to drive the ejector rod to move up and down, so that the other end of the ejector rod is movable relative to the through hole. The other end of the ejector rod is protruded from the lifting platen 2 to eject the to-be-processed workpiece 10, so that the user conveniently takes down the to-be-processed workpiece 10.

In an embodiment of this application, an outer wall surface of the upper platen 4 is disposed on a display, the control part is electrically connected to the display, and the display is configured to display remaining heat-pressing time of the to-be-processed workpiece 10.

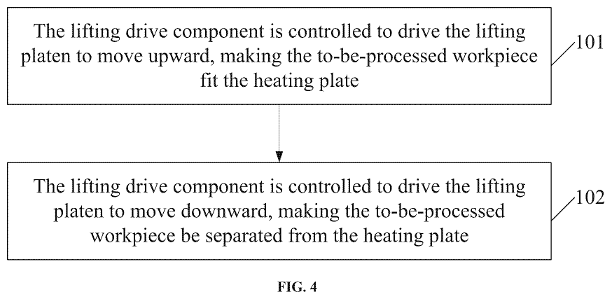

According to an embodiment in a second aspect of this application, as shown in FIG. 4, the method includes the following steps.

In step 101, the lifting drive component 3 is controlled to drive the lifting platen 2 to move upward, making the to-be-processed workpiece 10 fit the heating plate 41.

In step 102, the lifting drive component 3 is controlled to drive the lifting platen 2 to move downward, making the to-be-processed workpiece 10 be separated from the heating plate 41.

It may be understood that, when the upper platen 4 is in a closed state, and a temperature of the heating plate 41 is a preset temperature, the lifting drive component 3 is controlled to drive the lifting platen 2 to move upward, so that the to-be-processed workpiece 10 tightly fits the heating plate 41, to implement a heat-pressing operation on the to-be-processed workpiece 10. The lifting drive component 3 is controlled to be continuously in the current state, so that the lifting drive component 3 can apply stable force to the lifting platen 2, to implement a pressure-maintained heat-pressing operation of the lifting platen 2. After the heat-pressing operation is completed, the lifting drive component 3 is controlled to drive the lifting platen 2 to move downward, making the to-be-processed workpiece 10 be separated from the heating plate 41, so that a user can take down the to-be-processed workpiece 10.

In an embodiment of this application, before the step that the lifting drive component 3 is controlled to drive the lifting platen 2 to move upward, the control method further includes the following steps.

A material of the to-be-processed workpiece 10 is obtained.

A target heat-pressing duration and a target heat-pressing temperature are determined based on the material of the to-be-processed workpiece 10.

The step that the lifting drive component 3 is controlled to drive the lifting platen 2 to move upward includes the following steps.

It is determined that the temperature of the heating plate 41 reaches the target heat-pressing temperature.

The lifting drive component 3 is controlled to drive the lifting platen 2 to move upward.

It may be understood that, different materials correspond to different heat-pressing durations and heat-pressing temperatures, so that after the material of the to-be-processed workpiece 10 is obtained, a corresponding target heat-pressing duration and a corresponding target heat-pressing temperature can be driven based on the material of the to-be-processed workpiece 10. When the to-be-processed workpiece 10 is heat-pressed for the target heat-pressing duration at the target heat-pressing temperature, a heat-pressing effect can be guaranteed.

When the lifting drive component 3 is controlled to drive the lifting platen 2 to move upward, the temperature of the heating plate 41 is obtained. When the temperature of the heating plate 41 reaches the target heat-pressing temperature, the lifting drive component 3 is controlled to drive the lifting platen 2 to move upward, so that the heat-pressing effect of the to-be-processed workpiece 10 is guaranteed. After the to-be-processed workpiece 10 tightly fits the heating plate 41, the lifting drive component 3 is controlled to be in a static state for the target heat-pressing duration. After the target heat-pressing duration, the lifting drive component 3 is controlled to drive the lifting platen 2 to move downward, so that the heat-pressing effect is guaranteed.

For example, a detection part can be disposed at the lifting platen 2. When the to-be-processed workpiece 10 is placed on the lifting platen 2, the detection part abuts against the to-be-processed workpiece 10, so that the material of the to-be-processed workpiece 10 can be detected via the detection part. Furthermore, detection data of the detection part can be obtained to determine the material of the to-be-processed workpiece 10.

At last, it should be noted that the above implementations are only used for describing this application, and are not intended to limit this application. Although this application is described in detail with reference to the embodiments, those of ordinary skill in the art should understand that various combinations, modifications or equivalent substitutions may be made to the technical solutions of this application without departing from the spirit and scope of the technical solutions of this application, and such combinations, modifications or equivalent substitutions should be encompassed within the scope of the claims of this application.

What is claimed is:

1. An intelligent desktop heat press machine, comprising:
a base;
a lifting platen disposed on the base, wherein the lifting platen is movable relative to the base, and the lifting platen is configured to bear a to-be-processed workpiece;
a lifting drive component disposed on the base, wherein the lifting drive component is connected to the lifting platen, and the lifting drive component is configured to drive the lifting platen to ascend and descend;
an upper platen provided with a heating plate, wherein one end of the upper platen is rotatably connected to the base to switch between a closed state and an open state; in the closed state, the other end of the upper platen is fixedly connected to the base, and the heating plate and the lifting platen are disposed opposite to each other; and in the open state, the other end of the upper platen is spaced from the base; and
a control part, wherein the lifting drive component and the heating plate are both electrically connected to the control part, and the control part is configured to: control the heating plate to start working when the upper platen is in the closed state, and control the lifting drive component to drive the lifting platen to move toward the heating plate when a temperature of the heating plate reaches a preset temperature.

2. The intelligent desktop heat press machine according to claim 1, wherein the intelligent desktop heat press machine further comprises an induction component, the induction component is disposed on the base, the induction component is electrically connected to the control part, and the induction component is configured to detect a position of the lifting platen.

3. The intelligent desktop heat press machine according to claim 2, wherein the base comprises a mounting cavity, the lifting drive component comprises a lifting motor disposed in the mounting cavity, and a drive end of the lifting motor is connected to the lifting platen.

4. The intelligent desktop heat press machine according to claim 3, wherein the induction component is at least partially located in the mounting cavity.

5. The intelligent desktop heat press machine according to claim 1, wherein the induction component comprises an inductor and an induction sheet, the inductor is disposed in the mounting cavity, one end of the induction sheet is connected to the lifting platen, and the inductor is configured to induct a position of the induction sheet.

6. The intelligent desktop heat press machine according to claim 1, wherein the intelligent desktop heat press machine further comprises a heat dissipation fan, the heat dissipation fan is disposed on the upper platen, and the heat dissipation fan is configured to convey air to the heating plate.

7. The intelligent desktop heat press machine according to claim 1, wherein one end of the upper platen is rotatably connected to the base through a damping hinge.

8. The intelligent desktop heat press machine according to claim 1, wherein the intelligent desktop heat press machine further comprises a silicone pad, and the silicone pad is disposed on a side that is of the lifting platen and that is away from the base.

9. The intelligent desktop heat press machine according to claim 1, wherein the intelligent desktop heat press machine further comprises a locking component, the locking component is disposed on the upper platen; in the closed state, the locking component is fixedly connected to the upper platen and the base; and in the open state, the locking component is spaced from the base.

10. A control method of the intelligent desktop heat press machine according to claim 1, comprising:
controlling the lifting drive component to drive the lifting platen to move upward, such that the to-be-processed workpiece fits the heating plate; and
controlling the lifting drive component to drive the lifting platen to move downward, such that the to-be-processed workpiece is separated from the heating plate.
